(19) United States
(12) Patent Application Publication
(10) Pub. No.: US 2006/0135151 A1
(43) Pub. Date: Jun. 22, 2006

(54) Cordless IP telephone

(76) Inventors: Keming Mu, Fremont, CA (US); Paul Friedman, Berkeley, CA (US); Hui Deng, San Ramon, CA (US)

Correspondence Address: PATENT LAW GROUP LLP, 2635 NORTH FIRST STREET, SUITE 223, SAN JOSE, CA, 95134, US

(21) Appl. No.: 11/016,330

(22) Filed: Dec. 17, 2004

(51) Int. Cl. H04Q 7/20

(52) U.S. Cl. 455/426.1; 455/462

(57) ABSTRACT

A cordless telephone system includes a base station and a handset. The base station includes a telephone line interface, a base station chipset coupled to the telephone line interface, and a first radio transceiver coupled to the base station chipset. The handset includes a microphone, a speaker, a processor coupled to the microphone and the speaker, a wireless network interface coupled to the processor, a handset chipset coupled to the processor, and a second radio transceiver coupled to the wireless network interface and the handset chipset. The second radio transceiver is operable to communicate with the first radio transceiver and a third radio transceiver at a device coupled to a computer network. In a cordless telephone mode, a telephone call is communicated between the handset and the base station. In an IP telephone mode, an IP telephone call is communicated between the handset and the device.

### FIELD OF INVENTION

This invention relates to cordless telephones and Internet Protocol (IP) telephony.

### DESCRIPTION OF RELATED ART

A cordless telephone is basically a combination telephone and radio transmitter/receiver. A cordless telephone has two major parts: base station and handset.

The base station is attached to the telephone jack through a standard telephone wire connection, and as far as the telephone system is concerned it looks just like a normal telephone. The base station receives the incoming call (as an electrical signal) through the telephone line, converts it to an FM radio signal, and then broadcasts that signal.

The handset receives the radio signal from the base station, converts it to an electrical signal, and sends that signal to the speaker where it is converted into sound. When a user talks, the handset broadcasts his or her voice through a second FM radio signal back to the base. The base station receives the voice signal, converts it to an electrical signal, and sends that signal through the telephone line to the other party.

IP telephony is the two-way transmission of audio over a packet-switched IP network (e.g., a Transmission Control Protocol/Internet Protocol (TCP/IP) network). When used in a private intranet or WAN, it is generally known as “voice over IP” or “VoIP.” When the transport is the public Internet or the Internet backbone from a major carrier, it is generally called “IP telephony” or “Internet telephony.” However, the terms IP telephony, Internet telephony, and VoIP are often used interchangeably.

IP telephony uses two protocols: one for transport and another for signaling. Transport is provided by User Datagram Protocol (UDP) over IP for voice packets and either UDP or TCP over IP for signals. Signaling commands to establish and terminate the call as well as provide all special features such as call forwarding, call waiting and conference calling are defined in a signaling protocol such as H.323, Session Initiation Protocol (SIP), Media Gateway Control Protocol (MGCP), or MEdia GAteway COntroller (MEGACO).

IP telephony over controlled Internet backbones or an enterprise's own private network can provide quality matching that of the Public Switched Telephone Network (PSTN). All major carriers have implemented IP telephony behind the scenes, especially for international calls. Over the public Internet, voice quality varies considerably.

### BRIEF DESCRIPTION OF THE DRAWINGS

FIG. 1 illustrates a cordless IP telephone system in one embodiment of the invention.

FIG. 2 illustrates a block diagram of a handset in the system of FIG. 1 in one embodiment of the invention.

FIG. 3 illustrates a block diagram of a base station in the system of FIG. 1 in one embodiment of the invention.

FIG. 4 illustrates a block diagram of a computer in the system of FIG. 1 in one embodiment of the invention.

FIG. 5 illustrates the flow of sound data through the handset of FIG. 2 in a cordless telephone mode in one embodiment of the invention.

FIG. 6 illustrates the flow of sound data through the handset of FIG. 2 in an IP telephone mode in one embodiment of the invention.

FIG. 7 is a flowchart of the operations of the system of FIG. 1 in one embodiment of the invention.

Use of the same reference numbers in different figures indicates similar or identical elements.

### SUMMARY

In one embodiment of the invention, a cordless IP telephone system includes a base station and a handset. The base station includes a telephone line interface, a base station chipset coupled to the telephone line interface, and a first radio transceiver coupled to the base station chipset. The handset includes a microphone, a speaker, a processor coupled to the microphone and the speaker, a wireless network interface coupled to the processor, a handset chipset coupled to the processor, and a second radio transceiver coupled to the wireless network interface and the handset chipset. The second radio transceiver is operable to communicate with the first radio transceiver and a third radio transceiver at a device coupled to a computer network. In a cordless telephone mode, a telephone call is communicated between the handset and the base station. In an IP telephone mode, an IP telephone call is communicated between the handset and the device.

### DETAILED DESCRIPTION

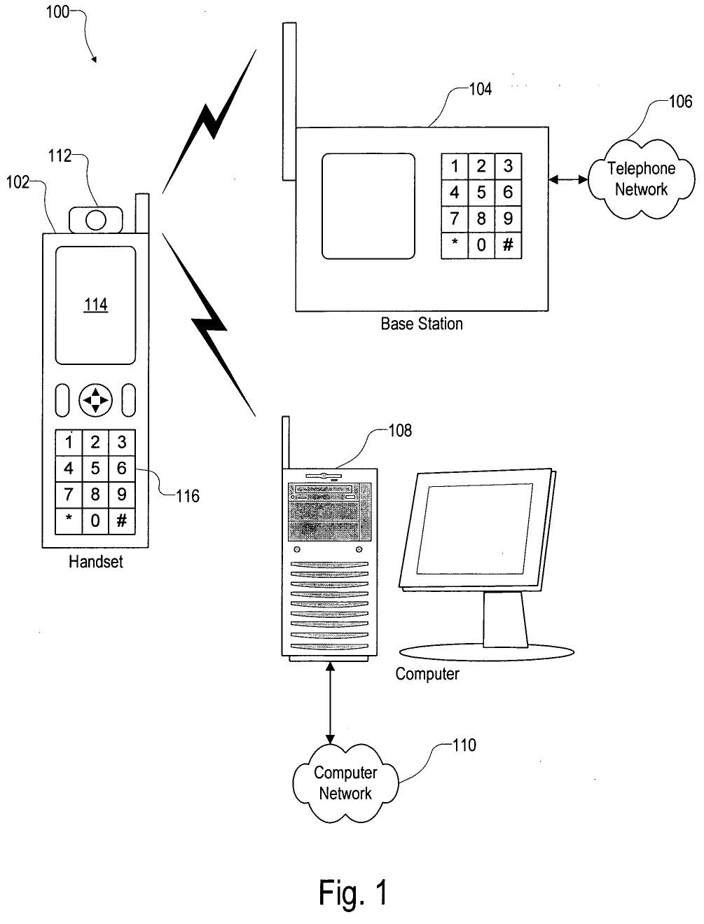

FIG. 1 illustrates a cordless IP telephone system 100 in one embodiment of the invention. System 100 includes a handset 102, a base station 104 coupled to a telephone network 106 (e.g., a PSTN), and a device 108 coupled to a computer network 110 (e.g., a public network such as the Internet or a private network). Device 108 may be a personal computer.

In a cordless telephone mode, a telephone call is made to and from system 100 through telephone network 106. In this mode, the conversation is wirelessly communicated between handset 102 and base station 104. In an IP telephone mode, an IP telephone call is made to and from system 100 through computer network 110. In this mode, the conversation is wirelessly communicated between handset 102 and computer 108.

Handset 102 also includes a camera 112 for capturing images and a display 114 for viewing images. An image can be wirelessly transmitted from handset 102 to computer 108, and then transmitted to a recipient through computer network 110. Similarly, an image can be received at computer 108 through computer network 110, and then wirelessly transmitted from computer 108 to handset 102.

Handset 102 can be used to compose emails and instant messages using a keypad 116. These text messages are wirelessly transmitted from handset 102 to computer 108, and then transmitted to the recipient through computer network 110. Similarly, emails and instant messages can be received at computer 108 through computer network 110, and then wirelessly transmitted from computer 108 to handset 102.

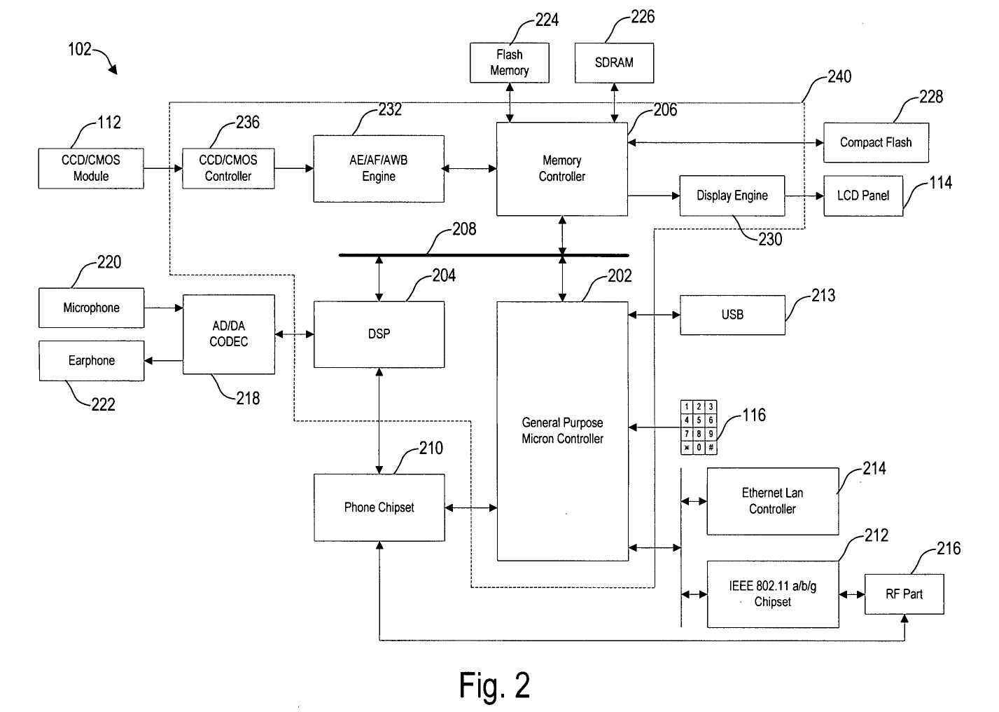

FIG. 2 illustrates a block diagram of handset 102 in one embodiment of the invention. Handset 102 includes a microprocessor 202, a digital signal processor (DSP) 204, and a memory controller 206 that communicate with each other through a system bus 208.

Microprocessor 202 is coupled to a cordless handset chipset 210, a wireless network interface 212, a universal serial bus (USB) interface 213, an Ethernet interface 214, and keypad 116. Handset chipset 210 may be any conventional cordless handset chipset. Wireless network interface 212 may be any conventional interface that conforms to an 802.11x standard. Handset chipset 210 and wireless network interface 212 are coupled to a radio transceiver 216. USB interface 213 is used to connect with an external USB storage device, such as a digital camera, to browse the content of the device. Ethernet interface 214 is a backup to wireless network interface 212 for communication with computer 108.

DSP 204 is coupled to handset chipset 210 and an analog-to-digital/digital-to-analog (AD/DA) converter 218. AD/DA converter 218 is coupled to a microphone 220 and a speaker 222.

Memory controller 206 is coupled to a flash memory 224, a RAM 226, a removable memory card 228, a display engine 230, and an imaging processor 232. Display engine 230 is coupled to display 114. Display 114 may be a liquid crystal display (LCD). Imaging processor 232 may be a conventional auto exposure, auto focus, and auto white balance (AE/AF/AWB) processor. Imaging processor 232 is coupled to an image sensor controller 236, which is in turn coupled to image sensor 112. Imaging sensor 112 may be a charge couple device (CCD) or complimentary metal oxide semiconductor (CMOS) image sensor. Image controller 236 provides the necessary logic signal to image sensor 112, such as timing signals, synchronization signals, and shutter control signals.

In one embodiment, microprocessor 202, DSP 204, memory controller 206, display engine 230, AE/AF/AWB processor engine 232, and CCD/CMOS controller 26 are part of a single processor 240. Processor 240 may be a TMS320DM270 Processor from Texas Instrument Inc. of Dallas, Tex. The operation of handset 102 in system 100 is described later.

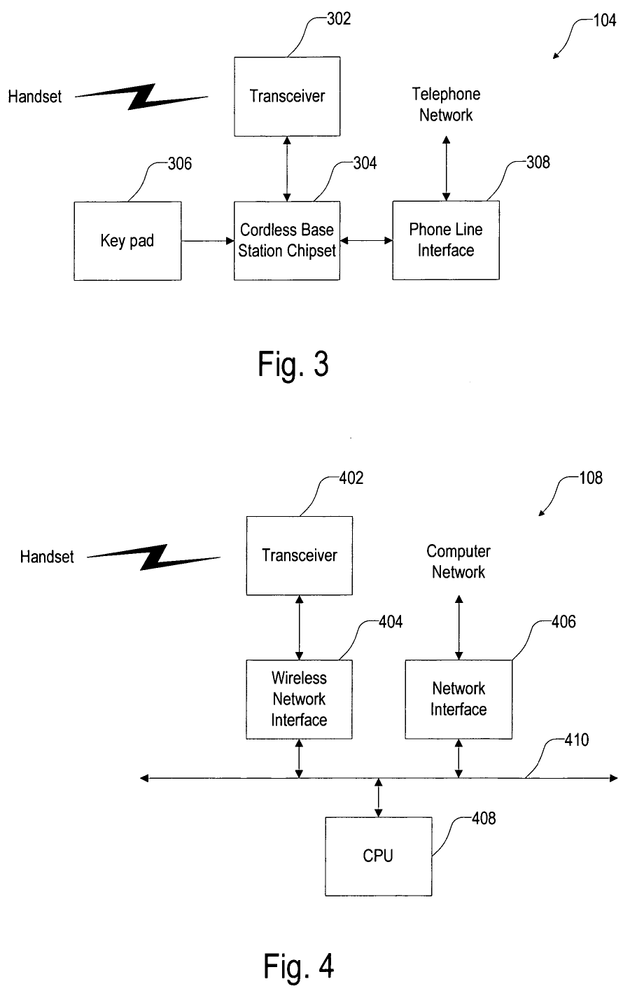

FIG. 3 illustrates a block diagram of base station 104 in one embodiment of the invention. Base station 104 includes a transceiver 302, a cordless base station chipset 304 coupled to the transceiver, a keypad 306 and a telephone line interface 308 coupled to base station chipset 304. Telephone line interface 308 is connected to telephone network 106. The operation of base station 104 in system 100 is described later.

FIG. 4 illustrates a block diagram of computer 108 in one embodiment of the invention. Computer 108 includes a transceiver 402, a wireless network interface 404 coupled to transceiver 402, a network interface 406 coupled to computer network 110, and a central processing unit (CPU) 408. Wireless network interface 404, network interface 406, and CPU 408 communicate with each other through a system bus 410. The operation of computer 108 in system 100 is described later.

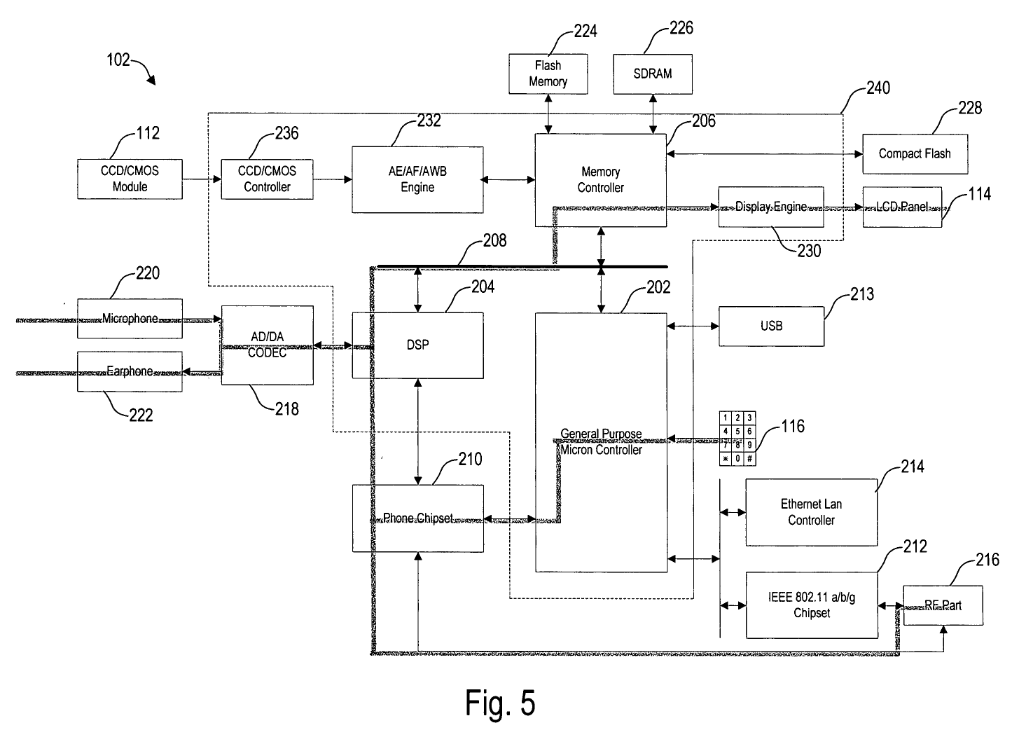

FIG. 5 illustrates the flow of sound data through handset 102 when system 100 is in the cordless telephone mode in one embodiment of the invention. When a first party using handset 102 speaks, the sound is picked up by microphone 220 and converted into electrical analog sound signals. AD/DA converter 218 converts the analog sound signals into digital sound signals. In the cordless mode, DSP 204 is configured in its bypass mode so it only passes the digital sound signals between AD/DA converter 218 and handset chipset 210. Handset chipset 210 then encodes the digital sound signals for radio transmission (e.g., DSS). Transceiver 216 then wirelessly transmits the encoded digital sound signals to transceiver 302 at base station 104.

Referring back to FIG. 3, base station chipset 304 decodes the digital sound signals and outputs them to the telephone line interface 308. Telephone line interface 308 converts the digital sound signals to analog sound signals and sends them over telephone network 106 to a second party participating in the Plain Old Telephone Service (POTS) telephone call.

Conversely, telephone line interface 308 receives analog sound signals of the second party from telephone network 106 and converts them into digital sound signals. Base station chipset 304 encodes the digital sound signals for radio transmission. Transceiver 302 then wirelessly transmits the encoded digital sound signals to transceiver 216 at handset 104.

Referring back to FIG. 5, handset chipset 210 decodes the digital sound signals and outputs them to DSP 204. In the cordless mode, DSP 204 is configured in its bypass mode so it only passes the digital sound signals between AD/DA converter 218 and handset chipset 210. AD/DA converter 218 then converts the digital sound signals into analog sound signals from which speaker 222 reproduces the sound of the second party for the first party.

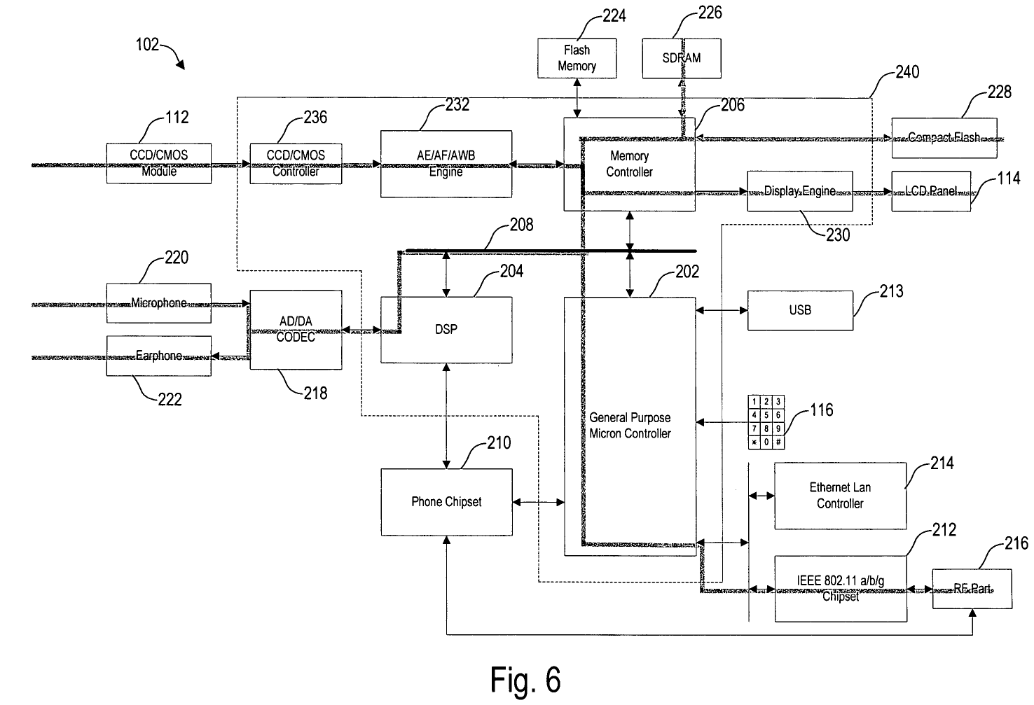

FIG. 6 illustrates the flow of sound data through handset 102 when system 100 is in the IP telephone mode in one embodiment of the invention. When a first party using handset 104 speaks, the sound is picked up by microphone 220 and converted into electrical analog sound signals. AD/DA converter 218 converts the analog sound signals into digital sound signals. In the IP phone mode, DSP 204 is used to encode (e.g., compress) the digital sound signals. Microprocessor 202 then passes the digital sound signals to wireless network interface 212. Wireless network interface 212 then encodes the digital sound signals for radio transmission. Transceiver 216 then wirelessly transmits the encoded digital sound signals to transceiver 402 at computer 108. Note that the radio frequencies used in the cordless telephone and the IP telephone modes are different.

Referring back to FIG. 4, wireless network interface 404 decodes the digital sound signals. CPU 408 then passes the digital sound signals to network interface 406. Network interface 406 sends the digital sound signals over computer network 110 to a second party participating in the IP telephone call.

Conversely, network interface 406 receives digital sound signals over computer network 110 from the second participant. CPU 408 passes the digital sound signals from the network interface 406 to wireless network interface 404, which encodes them for radio transmission. Transceiver 402 then wirelessly transmits the encoded digital sound signals to transceiver 216 at handset 104.

Referring back to FIG. 6, wireless network interface 212 decodes the digital sound signals. Microprocessor 202 passes the digital sound signal to DSP 204. In the IP phone mode, DSP 204 is used to decode (e.g., uncompress) the digital sound signal. AD/DA converter 218 then converts the digital sound signals into analog sound signals from which speaker 222 reproduces the sound of the second party for to the first party.

FIG. 6 also illustrates the flow of image data through handset 102 when system 100 is in the IP telephone mode in one embodiment of the invention. Under the instruction of a first party, image sensor 112 captures a digital image. Image controller 236 passes the image to imaging processor 232. Imaging processor 232 may be used to improve the picture quality. Memory controller 206 temporarily saves the image in RAM 226. Memory controller 206 may also save the image in a removable media card 228. Display engine 230 may retrieve the image from RAM 226 and present it in display 114.

As an alternative to the image being captured by the built-in camera, the image may be transferred from a USB device coupled to USB interface 213. Microprocessor 202 then passes the image to memory controller 206 so the image can be stored in RAM 226 for display.

Microprocessor 202 may pass the image to wireless network interface 212. Wireless network interface 212 then encodes the image for radio transmission. Transceiver 216 then wirelessly transmits the image to transceiver 402 at computer 108.

Referring back to FIG. 4, wireless network interface 404 decodes the image. CPU 408 then passes the image to network interface 406. Network interface 406 sends the image over compute network 110 to a second participant.

Conversely, network interface 406 receives a digital image over computer network 110 from the second party. CPU 408 passes the image from the network interface 406 to wireless network interface 404, which encodes it for radio transmission. Transceiver 402 then wirelessly transmits the image to transceiver 216 at handset 104.

Referring back to FIG. 6, wireless network interface 212 decodes the image. Microprocessor 202 passes the image to memory controller 206. Memory controller 206 temporarily saves the image in RAM 226. Memory controller 206 may also save the image in removable media card 228. Display engine 230 may retrieve the image from RAM 226 and present it in display 114.

FIG. 6 also illustrates the flow of text data through handset 102 when system 100 is in the IP telephone mode in one embodiment of the invention. A first party may input text data using keypad 116. The text data may be text messages in an email or an instant message. Microprocessor 202 passes the text data to wireless network interface 212. Wireless network interface 212 then encodes the text data for radio transmission. Transceiver 216 then wirelessly transmits the text data to transceiver 402 at computer 108.

Referring back to FIG. 4, wireless network interface 404 decodes the text data. CPU 408 then passes the text data network interface 406. Network interface 406 sends the text data over compute network 110 to a second party.

Conversely, network interface 406 receives text data over computer network 110 from the second party. CPU 408 passes the text data from the network interface 406 to wireless network interface 404, which encodes it for radio transmission. Transceiver 402 then wirelessly transmits the text data to transceiver 216 at handset 104.

Referring back to FIG. 6, wireless network interface 212 decodes the text data. Microprocessor 202 passes the text data to memory controller 206. Memory controller 206 temporarily saves the text data in RAM 226. Display engine 230 may retrieve the text data from RAM 226 and present it in display 114.

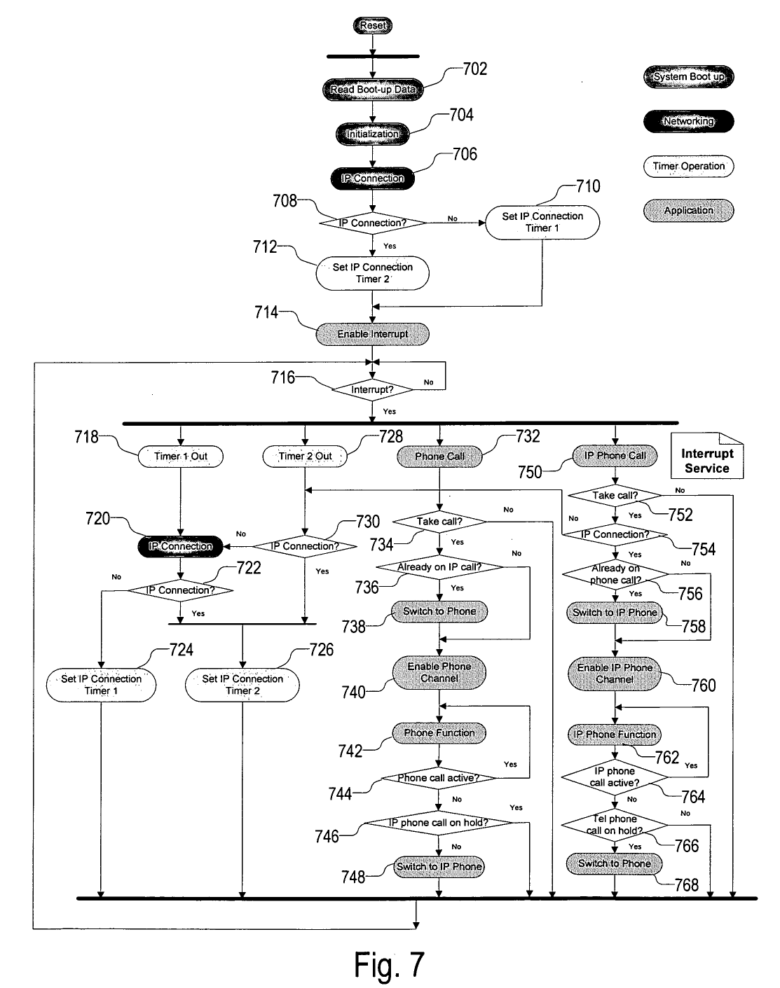

FIG. 7 is a flowchart that illustrates the operations of system 100 in one embodiment of the invention. In step 702, microprocessor 202 reads boot-up information from flash memory 224.

In step 704, microprocessor 202 initializes the various components of system 100.

In step 706, microprocessor 202 attempts to make a connection to compute network 110.

In step 708, microprocessor 202 determines if the connection has been established. If not, then step 708 is followed by step 710. If the connection has been established, then step 708 is followed by step 712.

In step 710, microprocessor 202 starts a first timer. When the first timer times out, an interrupt will be generated and in response microprocessor 202 will attempt to reconnect with computer network 110. Step 710 is followed by step 714.

In step 712, microprocessor 202 starts a second timer. When the second timer times out, an interrupt will be generated and in response microprocessor 202 will check on the connection to computer network 110. Step 712 is followed by step 714.

In step 714, microprocessor 202 waits for an interrupt.

In step 716, microprocessor 202 determines if an interrupt has been generated. If microprocessor 202 receives a first timer interrupt, then step 716 is followed by step 718. If microprocessor 202 receives a second timer interrupt, then step 716 is followed by step 728. If microprocessor 202 receives a POTS telephone call interrupt, then step 716 is followed by step 732. If microprocessor 202 receives an IP telephone call interrupt, then step 716 is followed by step 750.

First Timer Interrupt

In step 718, microprocessor 202 determines that the interrupt is a first timer interrupt. Step 718 is followed by step 720.

In step 720, microprocessor 202 attempts to reconnect to computer network 110. Step 720 is followed by step 722.

In step 722, microprocessor 202 determines if the connection has been established. If not, then step 722 is followed by step 724. If the connection has been established, then step 722 is followed by step 726.

In step 724, microprocessor 202 resets and restarts the first timer. Step 724 is followed by step 716 where microprocessor 202 waits for another interrupt.

In step 726, microprocessor 202 resets and restarts the second timer. Step 726 is followed by step 716 where microprocessor 202 waits for another interrupt.

Second Timer Interrupt

In step 728, microprocessor 202 determines that the interrupt is a second timer interrupt. Step 728 is followed by step 730.

In step 730, microprocessor 202 determines if the connection has been maintained. If not, then step 730 is followed by the previously described step 720. If the connection has been maintained, then step 730 is followed by step 726.

POTS Telephone Call Interrupt

In step 732, microprocessor 202 determines that the interrupt is a POTS telephone call interrupt. Step 732 is followed by step 734.

In step 734, microprocessor 202 determines if the user wishes to take the call by prompting the user. If so, step 734 is followed by step 736. If the user does not wish to take the call, then step 734 is followed by step 716 where microprocessor 202 waits for another interrupt.

In step 736, microprocessor 202 determines if system 100 is currently in the IP telephone mode because the user is on an IP telephone call. If so, then step 736 is followed bys step 738. If system 100 is not currently in the IP telephone mode, then step 736 is followed by step 740.

In step 738, microprocessor 202 puts the IP telephone call on hold so the user can switch to the POTS telephone call. Step 738 is followed by step 740.

In step 740, microprocessor 202 puts system 100 in the cordless telephone mode by enabling the telephone channel as described above in reference to FIG. 5. Step 740 is followed by step 742.

In step 742, system 100 performs the cordless telephone functions as described above in reference to FIG. 5. Step 742 is followed by step 744.

In step 744, microprocessor 202 determines if the POTS telephone call is still active. If so, step 744 is followed by step 742. If the POTS telephone call has ended, then step 744 is followed by step 746.

In step 746, microprocessor 202 determines if there is an IP telephone call on hold. If so, step 746 is followed by step 748. If there is no IP telephone call on hold, then step 746 is followed by step 716 where microprocessor 202 waits for another interrupt.

In step 748, microprocessor 202 switches system 100 to IP telephone mode so the user can continue the IP telephone call.

IP Telephone Call Interrupt

In step 750, microprocessor 202 determines that the interrupt is an IP telephone call interrupt. Step 750 is followed by step 752.

In step 752, microprocessor 202 determines if the user wishes to take the IP telephone call by prompting the user. If so, step 752 is followed by step 754. If the user does not wish to take the IP telephone call, then step 752 is followed by step 716 where microprocessor 202 waits for another interrupt.

In step 754, microprocessor 202 determines if the connection to computer network 110 has been maintained. If so, then step 754 is followed by step 756. If the connection to computer network 110 has not been maintained, then step 754 is followed by the previously described step 730.

In step 756, microprocessor 202 determines if system 100 is currently in the cordless telephone mode because the user is on a POTS telephone call. If so, then step 756 is followed bys step 758. If system 100 is not currently in the cordless telephone mode, then step 756 is followed by step 760.

In step 758, microprocessor 202 puts the POTS telephone call on hold so the user can switch to the IP telephone call. Step 758 is followed by step 760.

In step 760, microprocessor 202 puts system 100 in the IP telephone mode by enabling the IP channel as described above in reference to FIG. 6. Step 760 is followed by step 762.

In step 762, system 100 performs the IP telephone functions as described above in reference to FIG. 6. Step 762 is followed by step 764.

In step 764, microprocessor 202 determines if the IP telephone call is still active. If so, step 764 is followed by step 762. If the IP telephone call has ended, then step 764 is followed by step 766.

In step 766, microprocessor 202 determines if there is a POTS telephone call on hold. If so, step 766 is followed by step 768. If there is no POTS telephone call on hold, then step 766 is followed by step 716 where microprocessor 202 waits for another interrupt.

In step 768, microprocessor 202 switches system 100 to the cordless telephone mode so the user can continue the telephone call.

Various other adaptations and combinations of features of the embodiments disclosed are within the scope of the invention. Numerous embodiments are encompassed by the following claims.

What is claimed is:

1. A cordless telephone system, comprising:
a base station, comprising:
a telephone line interface;
a base station chipset coupled to the telephone line interface;
a first radio transceiver coupled to the base station chipset;
a handset, comprising:
a microphone;
a speaker;
a processor coupled to the microphone and the speaker
a first wireless network interface coupled to the processor;
a handset chipset coupled to the processor;
a second radio transceiver coupled to the first wireless network interface and the handset chipset, the second radio transceiver operable to communicate with the first radio transceiver and a third radio transceiver at a device coupled to a computer network;
wherein the system is configured in a cordless telephone mode as follows:
a first sound is communicated in a first path comprising the telephone line interface, the base station chipset, the first radio transceiver, the second radio transceiver, the handset chipset, the processor, and the speaker; and
a second sound is communicated in a second path comprising the microphone, the processor, the handset chipset, the second radio transceiver, the first radio transceiver, the base station chipset, and the telephone line interface;
wherein the system is configured in an IP telephone mode as follows:
a third sound is communicated in a third path comprising the computer network, the third radio transceiver, the second radio transceiver, the first wireless interface, the processor, and the speaker; and
a fourth sound is communicated in a fourth path comprising the microphone, the processor, the first wireless interface, the second radio transceiver, the third radio transceiver, and the computer network.

2. The system of claim 1:
wherein the device comprises a computer, the computer comprising:
a network interface coupled to the computer network;
a second wireless interface coupled to the network interface; and
the third radio transceiver coupled to the second wireless interface.

3. The system of claim 2:
wherein the handset further comprises:
an image sensor coupled to the processor, the image sensor for capturing an image;
a memory coupled to the processor, the memory for storing the image;
a display coupled to the processor, the display for presenting the image;
wherein the system is further configured in the IP telephone mode as follows:
the image is communicated in a fifth path comprising the memory, the processor, the first wireless interface, the second radio transceiver, the third radio transceiver, and the computer network.

4. The system of claim 3, wherein the processor comprises:
an image sensor controller coupled to the image sensor;
an image processor coupled to the image sensor controller;
a memory controller coupled to the image processor and the memory;
a display engine coupled to the memory controller;
a microprocessor coupled to the memory controller, the first wireless interface, and the handset chipset; and
a digital signal processor coupled to the memory controller, the microphone, the speaker, and the handset chipset.

5. The system of claim 1:
wherein the handset further comprises:
a memory coupled to the processor, the memory for storing an image;
a display coupled to the processor, the display for presenting the image;
wherein the system is further configured in the IP telephone mode as follows:
the image is communicated in a fifth path comprising the computer network, the third radio transceiver, the second radio transceiver, the first wireless interface, the processor, and the memory, wherein the second image is presented on the display.

6. The system of claim 1:
wherein the handset further comprises a keypad coupled to the processor;
wherein the system is further configured in the IP telephone mode as follows:
a text message is communicated in a fifth path comprising the key pad, the processor, the first wireless interface, the second radio transceiver, the third radio transceiver, and the computer network.

7. The system of claim 1:
wherein the handset further comprises a display coupled to the processor;
wherein the system is further configured in the IP telephone mode as follows:
a text message is communicated in a fifth path comprising the computer network, the third radio transceiver, the second radio transceiver, the first wireless interface, the processor, wherein the second image is presented on the display.

8. A method for operating a cordless telephone system, comprising:
powering-up the system;
attempting to connect to a computer network;
when a telephone call is detected:
switching the system to a cordless telephone mode;
performing cordless telephone functions;
when an IP telephone call is detected:
switching the system to an IP telephone mode;
performing IP telephone functions.

9. The method of claim 8, wherein said performing cordless telephone functions comprises:
capturing a first sound with a microphone on a handset;
wirelessly transmitting the first sound from the handset to a base station;
transmitting the first sound from the base station to a telephone network;
receiving a second sound at the base station from a telephone network;
wirelessly transmitting the second sound from the base station to the handset; and
playing the second sound with a speaker on the handset.

10. The method of claim 8, wherein said performing IP telephone functions comprises:
capturing a first sound with a microphone on a handset;
wirelessly transmitting the first sound from the handset to a device coupled to the computer network;
transmitting the first sound from the device to the computer network;
receiving a second sound at the device from the computer network;
wirelessly transmitting the second sound from the device to the handset;
playing the second sound with a speaker on the handset.

11. The method of claim 10, wherein said performing IP telephone functions further comprises:
capturing an image with an image sensor on the handset;
wirelessly transmitting the image to the device; and
transmitting the image from the device to the computer network.

12. The method of claim 10, wherein said performing IP telephone functions further comprises:
receiving an image at the device from the computer network;
wirelessly transmitting the image from the device to the handset; and
displaying the image on a display on the handset.

13. The method of claim 10, wherein said performing IP telephone functions further comprises:
receiving a text message with a keypad on the handset;
wirelessly transmitting the text message to the device; and
transmitting the image from the device to the computer network.

14. The method of claim 10, wherein said performing IP telephone functions further comprises:
receiving a text message at the device from the computer network;
wirelessly transmitting the text message from the device to the handset; and
displaying the text message on a display on the handset.

15. The method of claim 8, after said attempting to connect to the compute network, further comprising:
if a connection is not established with the compute network:
starting a first timer;
when the first timer times out, reattempting to connect to the computer network;
if the connection is established with the computer network:
starting a second timer;
when the second timer times out:
determining if the connection has been maintained;
if the connection has not been maintained, reattempting to connect to the computer network.

16. The method of claim 8, further comprising:
when the telephone call is detected after the system is in the IP telephone mode:
prompting a user to switch over to the cordless telephone mode to take the telephone call;
if the user agrees:
switching the system to the cordless telephone mode;
performing the cordless telephone functions;
when the IP telephone call is detected after the system is in the cordless telephone mode:
prompting the user to switch over to the IP telephone mode to take the IP telephone call;
if the user agrees:
switching the system to the IP telephone mode;
performing the IP telephone functions.
